(19) United States
(12) Patent Application Publication
(10) Pub. No.: US 2024/0317423 A1
(43) Pub. Date: Sep. 26, 2024

(54) Remote Operation System for Passenger Boarding Bridges for Craft and Arrangement of Passenger Boarding Bridges for Craft

(71) Applicant: Adelte Airport Technologies, S.L.,, Barcelona (ES)

(72) Inventor: Javier Martin Molina, Barcelona (ES)

(73) Assignee: Adelte Airport Technologies, S.L.,, Barcelona (ES)

(21) Appl. No.: 18/580,600

(22) PCT Filed: Jul. 20, 2022
(86) PCT No.: PCT/ES2022/070474

§ 371 Date: Jan. 18, 2024

(30) Foreign Application Priority Data
Jul. 22, 2021 (ES) P202130698

(51) Int. Cl. B64F 1/305; B64F 1/00

(52) U.S. Cl. CPC B64F 1/305; B64F 1/002

(57) ABSTRACT

A remote operation system for passenger boarding bridges for craft comprises display means to display the environment of the bridge. Image-capture means is designed to capture an area around the bridge. Interaction means allowing a user-controller to interact with the system is designed such that the user/controller can introduce and/or alter operating parameters for the system. Manual control means is accessible to the user/controller of the system. Indicator means indicates an operating situation of the bridge. These means linked by means of a control unit that controls movement elements of the bridge. The control unit incorporates a correction circuit for latency management through software, establishing latency values in the signals generated from the interaction means to the movement elements of the bridge, such that in the event that the control unit detects a value greater than the predetermined latency value, the control unit generates a signal that activates emergency stop means that are provided on movement elements of the bridge.

### OBJECT OF THE INVENTION

The object of this invention is to provide a remote operation system for passenger boarding bridges for craft, in air or port facilities, which incorporates notable innovations and advantages over the techniques used up to now.

More specifically, the invention proposes the development of a remote operation system for one or more passenger boarding bridges for craft, which enables operation and positioning of the bridge at a distance, without the need for the user controller to be physically present on the bridge itself, the possibility being provided of operating from one or more remote control points and providing greater functioning accuracy during the execution of operation manoeuvres.

### BACKGROUND OF THE INVENTION

Boarding bridges present in airports and ports, and used for passenger boarding or landing in airplanes or vessels, are well known in the current art.

It is therefore common to use passenger boarding bridges to facilitate the manoeuvres of boarding and landing passengers from passenger craft. The operation of connecting the passenger boarding bridge with an airplane, for example, is carried out by operators-controllers who operate the bridge by means of a control panel. This means that, to carry out this operation, an operator-controller with experience and training to carry out such a manoeuvre is required, since a collision could cause significant damage to the airplane or to the bridge.

In large airports with a large volume of air traffic, the number of operators-controllers with the ability to operate must be very high, since their presence is required both to connect and disconnect the bridge and the airplane.

However, the effective time required by an operator to carry out the manoeuvres is minimal, and most of their time is idle or waiting time, or time used to move from one position to another, or to remain in the bridge cabin waiting for the entry and subsequent parking of the aircraft, or awaiting in case of bridge failure until it is resolved, therefore not being able to attend other services.

To solve the above problem, document ES 2525955 is known, which describes a remote operation system for bridges that enables the operation and positioning of the bridge at a distance, without the need for the user controller to be physically on the bridge.

Although the previous system complies satisfactorily, it has been observed that there are some aspects to be improved during the execution of operation manoeuvres, since remote management can give rise to errors due to the latency that can occur from the order given by the user-controller until the execution of the orders by the mechanical elements that are part of the bridge.

Furthermore, the applicant is currently unaware of an invention that has all the features described in this specification.

### DESCRIPTION OF THE INVENTION

The present invention has been developed with the aim of providing a remote operation system which is configured as a novelty within the field of application and solves the previously mentioned drawbacks, also contributing other additional advantages that will be obvious from the description below.

It is therefore an object of the present invention to provide a remote operation system for passenger boarding bridges for craft, comprising display means designed to display the environment of the bridge to a user-controller, image-capture means designed to capture the area around the bridge, interaction means allowing a user-controller to interact with the system designed such that the user-controller can introduce and/or alter operating parameters for the system, manual control means accessible to the user-controller of the system, and indicator means for indicating the operating situation of the bridge, such that all of them are linked in data communication by means of data transmission means with a control unit with the capacity to process such data, the control unit being able to control the movement elements of the bridge according to the data communication received from the manual control means.

In particular, the invention is characterised in that the control unit incorporates a correction circuit for latency management through software, establishing latency values in the signals generated from the interaction means to the movement elements of the bridge, such that in the event the control unit detects a value greater than the predetermined latency value, the control unit generates a signal that activates emergency stop means that are provided on the movement elements of the bridge.

Due to these features, the operation of the management and control of boarding bridges is improved by improving the accuracy of movements due to the arrangement of a system that allows latency to be controlled, reducing the risk of avoiding manoeuvres that could hit or damage the bridge. during the operations for approaching the craft (airplane or vessel) to be managed.

According to another aspect of the invention, the system includes detection means configured to detect the accurate position in space of a door of the aircraft to be treated, detecting the outer contour of the door, said detection means being linked through the control unit with an autonomous operation system.

Preferably, the detection means comprise at least one laser sensor located in the docking area of the bridge.

Preferably, the interaction means allowing a user-controller to interact with the system comprises a camera display screen and an auxiliary touch screen provided to manage auxiliary functions and/or configuration.

Advantageously, the data transmission means are wireless, thus reducing the number of components and simplifying the system.

In a preferred embodiment, these data transmission means are a Wi-Fi connection or through a 4G or 5G communication network.

In addition, the control unit comprises at least one microprocessor, further incorporating software designed for data processing and management.

It is another object of the present invention to provide an arrangement of passenger boarding bridges for craft, comprising a plurality of passenger boarding bridges for craft that are managed by means of an operation system described above.

Thus, the system described represents an innovative structure with structural and constituent features heretofore unknown for its intended purpose, reasons which, taken together with its usefulness, provide it with sufficient grounds for obtaining the requested exclusivity privilege.

Other features and advantages of the remote operation system object of the present invention will be evident in light of the description of a preferred, but not exclusive, embodiment which is illustrated by way of non-limiting example in the drawings which are attached, in which:

### BRIEF DESCRIPTION OF THE DRAWINGS

FIG. 1 is a schematic view of the different elements involved in a preferred embodiment of the remote operation system of the present invention;

FIG. 2 is a schematic view of the interaction between different elements involved in the invention and the passenger craft being an airplane;

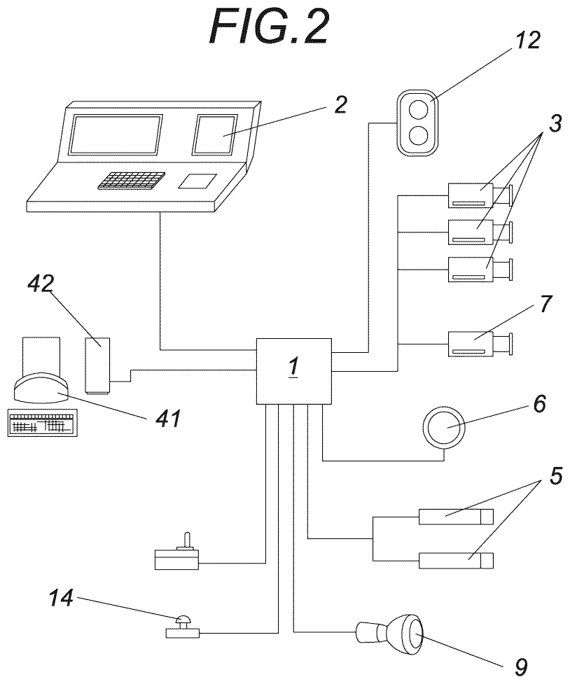

FIG. 3 is a perspective view of a boarding bridge intended to function with the remote operation system of the invention;

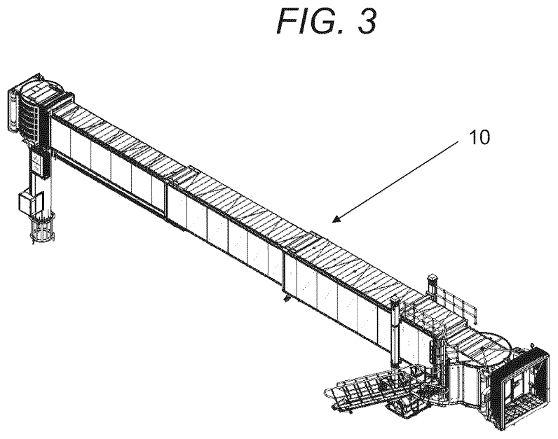

FIG. 4 is a schematic detail perspective view of a bridge used in the system according to the invention;

FIG. 5 is a perspective view of a bridge with a detailed view of the area of the wheels; and

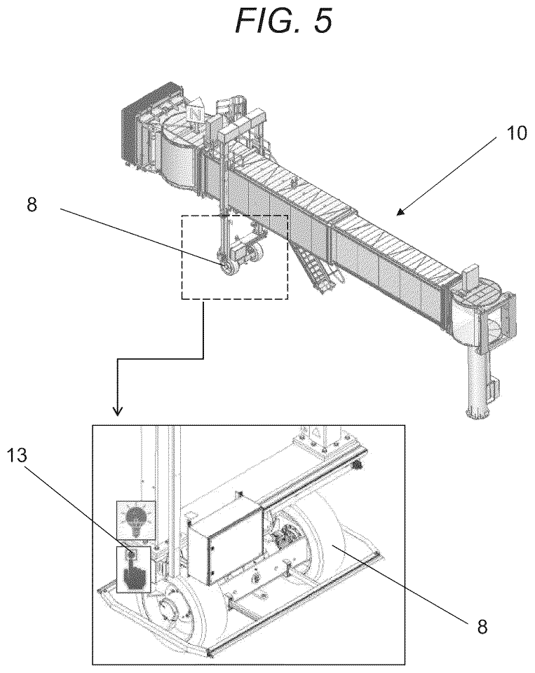

FIG. 6 is a schematic view of the system according to the invention that can be applied to manage a plurality of boarding bridges through a single control unit.

### DESCRIPTION OF A PREFERRED EMBODIMENT

In light of the aforementioned figures, and in accordance with the adopted numbering, one may observe therein a preferred exemplary embodiment of the invention, which comprises the parts and elements indicated and described in detail below.

Furthermore, the terms first, second, third, and the like in the description and claims are used to distinguish between similar items and not necessarily to describe a sequential or chronological order. The terms may be interchanged in appropriate circumstances and embodiments of the invention may operate in other sequences than those described or illustrated herein.

Furthermore, the terms upper, lower, and the like in the description and claims are used for descriptive purposes and not necessarily to describe relative positions.

The remote operation system for passenger boarding bridges for craft, being applicable to airport or port facilities, comprises display means designed to display images to a user-controller; image-capture means designed to capture an area around the bridge (10), interaction means allowing a user-controller to interact with the system, designed such that the user/controller can introduce and/or alter operating parameters for the system; manual control means accessible to the user/controller of the system; and indicator means for indicating the operating situation of the bridge (10), such that all of them are linked in data communication by means of data transmission means with a control unit (1) with the capacity to process such data, allowing the control unit (1) to control the movement elements (6) of the bridge (10) according to the data communication received from the manual control means.

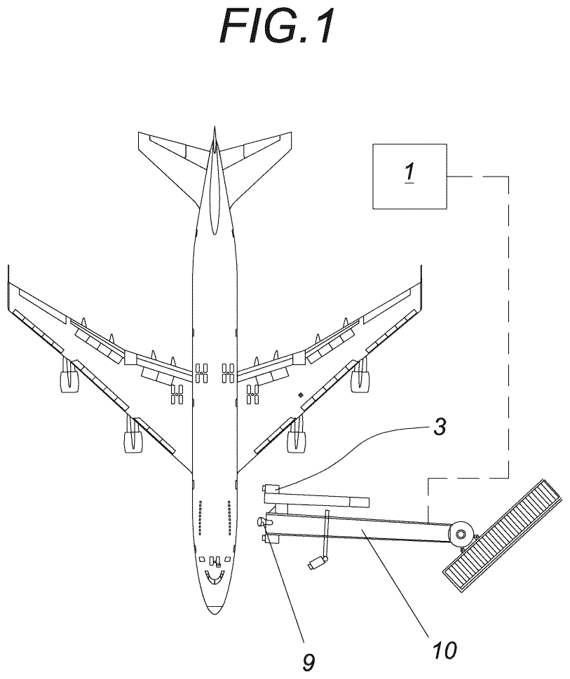

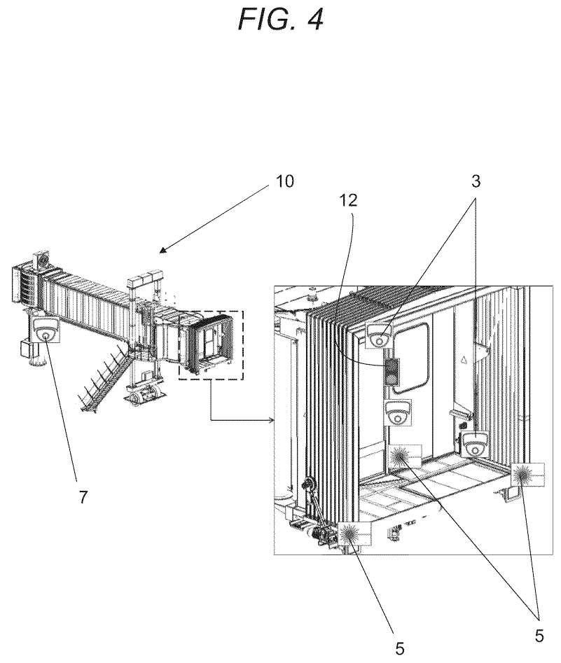

As shown schematically in FIG. 1 for this preferred embodiment of the remote operation system for passenger boarding bridges for craft of the present invention, the display means comprises a plurality of monitors (2), and the image-capture means have a plurality of cameras (3), such that the cameras communicate the image-forming data to the control unit (1), which processes and transmits such data to the monitors (2) that carry out the display of the images that can be perceived by the user-controller. As shown in FIG. 4, cameras (3) are located at different locations or areas of the bridge, wherein a camera is provided in the zenithal docking area, a front docking camera, and a diagonal docking camera. In addition, an additional camera (7) is provided that focusses on the area of the wheel axle (8), which allows detecting possible obstacles in the trajectory area that could damage the wheels or cause an unwanted accident, as schematically shown in FIG. 4.

Furthermore, illumination means are provided, schematically indicated with the reference (9), which are linked to the control unit (1) intended to have adequate illumination of the area around the bridge (10).

The control unit (1) comprises at least one microprocessor, which incorporates software designed for processing and managing the data provided to allow the remote autonomous operation of one or multiple bridges.

In the area of the wheel axle (8) a button (13) is provided to be pressed by operator present in the airport runway area, which must be pressed when the airplane meets all the conditions so that the passenger boarding bridge can start the movement.

In any case, the operator-controller has sufficient visual information to adequately control the bridge (10).

It should be noted that the control unit (1) incorporates a correction circuit for latency management through software, establishing latency values in the signals generated from the interaction means to the movement elements (6) of the bridge (10), including the wheels (8), such that in the event that the control unit detects a value greater than the predetermined latency value, the control unit (1) generates a signal that activates emergency stop means that are provided on the movement elements of the bridge (10). These stop means have a mushroom-shaped button (14) easily accessible directly by the user-controller that will allow the emergency stop of the movement elements of the bridge (10) in the event of any eventuality that requires it.

The system includes detection means configured to detect the accurate position in space of a door of the aircraft to be treated, detecting the outer contour of the door, said detection means being linked through the control unit (1) with an autonomous operation system. When the operation of the bridge (10) is carried out by means of the autonomous operation mode, a system is activated that prevents it from being manually driven by a user-controller at the same time, thus avoiding the generation of duplicate orders or orders that may be contradictory.

Preferably, the detection means comprise a plurality of laser sensors (5) of a known type (for which reason their description will not go into greater detail), which are located in the docking area of the bridge, as represented in FIG. 4, so that they provide a series of advantages since they allow the accurate distance between the boarding bridge and the body of the airplane to be measured, or a reference point to be generated that allows the operator to know the precise coupling position between the aircraft door and the area for accessing the boarding bridge.

Additionally, indicator means linked to the control unit (1) are also provided to indicate access to the interior of the boarding bridge from the aircraft, which consist of a traffic light (12) with two different colours for indicating access to or prohibition from the interior of the bridge, for example, for the crew.

The interaction means allowing a user-controller to interact with the system comprise a touch screen (41), similar to an interface installed on a computer (42). Through them, the user-controller can interact with the operation of the system, introducing and/or altering different characteristic parameters of the functioning thereof, such as bridge (10) selection, password management, platform levelling, bellows control as well as other elements or systems provided for the local control of known passenger boarding bridges.

The data transmission means can be wireless, so that the number of components is reduced and the system is simplified, such as a Wi-Fi connection or through a 4G or 5G communication network or it can be through copper cable or optic fibre.

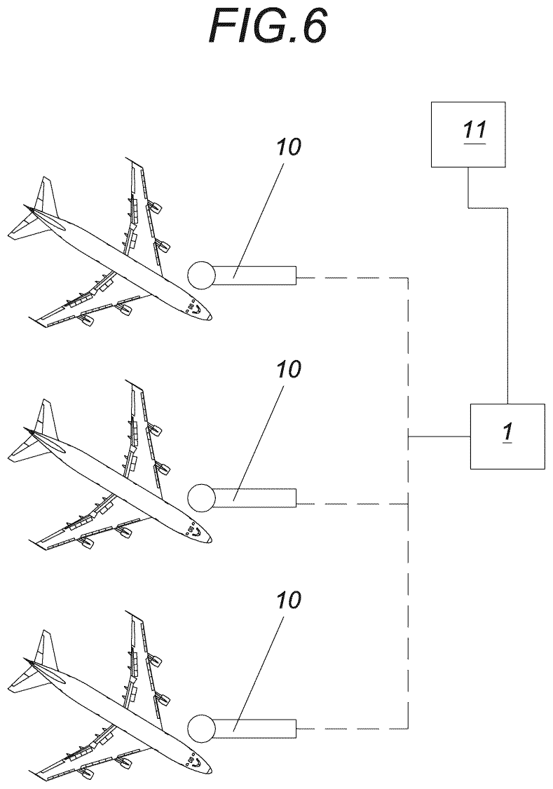

The control unit (1) can be connected to the operations database (11) of an airport (as shown in FIG. 6) in order to facilitate and distribute the boarding bridges (10) in a more effective and predictable manner.

The details, shapes, dimensions and other accessory elements, used to manufacture the remote operation system of the invention, may be suitably substituted for others which do not depart from the scope defined by the claims which are included below.

1. A remote operation system for passenger boarding bridges for craft, comprising display means configured to display an environment of a bridge to a user-controller, image-capture means provided to capture the area around the bridge, interaction means allowing a user-controller to interact with the system designed such that the user-controller allows to introduce or alter operating parameters for the system, manual control means accessible to the user-controller of the system, and indicator means for indicating an operating situation of the bridge, such that the display means, the user-controller, the image-capture means and the interaction means are linked in data communication by means of data transmission means with a control unit with the capacity to process data, the control unit being able to control movement elements of the bridge according to the data communication received from the manual control means, wherein the control unit incorporates a correction circuit for latency management through a software, establishing latency values in signals generated from the interaction means to the movement elements of the bridge, such that in the event that the control unit detects a value greater than a predetermined latency value, the control unit generates a signal that activates emergency stop means that are provided on the movement elements of the bridge.

2. The remote operation system for passenger boarding bridges for craft according to claim 1, further comprising detection means configured to detect the accurate position in space of a door of the aircraft to be treated, detecting the outer contour of the door, said detection means being linked through the control unit with an autonomous operation system.

3. The remote operation system for passenger boarding bridges for craft according to claim 2, wherein the detection means comprise at least one laser sensor located in the docking area of the bridge.

4. The remote operation system for passenger boarding bridges for craft according to claim 1, wherein the interaction means allowing a user-controller to interact with the system comprise at least one camera display screen and an auxiliary touch screen provided to manage auxiliary functions and/or configuration.

5. The remote operation system for passenger boarding bridges for craft according to claim 1, wherein the data transmission means are wireless.

6. The remote operation system for passenger boarding bridges for craft according to claim 1, wherein the data transmission means are a Wi-Fi connection or through a 4G or 5G communication network.

7. The remote operation system for passenger boarding bridges for craft according to claim 1, wherein the control unit comprises at least one microprocessor.

8. The remote operation system for passenger boarding bridges for craft according to claim 1, wherein the control unit incorporates software provided to data process and management.

9. The remote operation system for passenger boarding bridges for craft according to claim 1, wherein the passenger craft is an airplane.

10. The remote operation system for passenger boarding bridges for craft according to claim 1, wherein the passenger craft is a vessel.

11. The remote operation system for passenger boarding bridges for craft according to claim 1, further comprising indicator means for access to the interior of the boarding bridge from the aircraft, said indicator means being linked with the control unit.

12. The remote operation system for passenger boarding bridges for craft according to claim 11, wherein the indicator means consist of lighting means with different colours for indicating access or prohibition.

13. The remote operation system for passenger boarding bridges for craft according to claim 1, wherein the emergency stop means have a mushroom-shaped button accessible by the user-controller.

14. An arrangement of passenger boarding bridges for craft, comprising a plurality of passenger boarding bridges for craft that are managed by means of an operation system according to claim 1.
